(19) United States
(12) Patent Application Publication
(10) Pub. No.: US 2010/0163750 A1
(43) Pub. Date: Jul. 1, 2010

(54) ARTICLE WITH GRADATED ENVIRONMENTAL SENSOR

(76) Inventors: Bernard B. Hunwick, III, Westbury, NY (US); Kyle Lutz, Huntington Station, NY (US)

Correspondence Address: KAUTH , POMEROY , PECK & BAILEY ,LLP, 2875 MICHELLE DRIVE, SUITE 110, IRVINE, CA, 92606, US

(21) Appl. No.: 12/365,035

(22) Filed: Feb. 3, 2009

Related U.S. Application Data
(63) Continuation-in-part of application No. 12/347,220, filed on Dec. 31, 2008.

(51) Int. Cl. G01N 21/00

(52) U.S. Cl. 250/474.1

(57) ABSTRACT

An environmental exposure indicator sensor, such as, for example, UV exposure indicator sensors and its use with consumer bottles or containers is provided. Specifically, an environmental exposure indicator sensor, such as a UV or heat exposure indicator sensor is applied to the surface of a bottle or container to be used as a means of providing its user with information about the ambient environment (e.g., UV or heat radiation) incident on said bottle or container, and therefore the user's exposure to that environment.

### RELATED APPLICATIONS

This application is a continuation-in-part of U.S. application Ser. No. 12/347,220 filed Dec. 31, 2008, the disclosure of which is incorporated herein by reference.

### FIELD OF THE INVENTION

The present invention is directed to a consumer product bottle having an environmental indicator sensor integrated thereon; and particularly to a sunscreen bottle having a gradated UV exposure indicator sensor integrated therewith.

### BACKGROUND OF THE INVENTION

UV radiation is commonly known to be damaging to skin and is an established risk of skin cancer. Basal cell carcinoma is the most common skin cancer with greater than 400,000 cases per year in the USA alone. Squamous cell carcinoma is the second most common skin cancer with between 80,000 and 100,000 cases annually in the USA, and malignant melanoma is the most aggressive form of skin cancer with over 25,000 annual cases in the USA resulting in about 6,000 deaths.

There are many factors that can modify acceptable levels of sun exposure including altitude; skin complexion; amount of cover; and genetic disorders, such as xeroderma pigmentosum which is a mutation in a genetic repair mechanism that impairs the ability of the skin cells to repair themselves when damaged by UV radiation exposure. People with xeroderma pigmentosm have a skin repair mechanism that is grossly compromised and can lead to the development of skin cancer with extremely shortened UV radiation exposure times when compared to that of individuals with the more common functioning version of this genetic repair mechanism. It is noteworthy that regardless, damage occurs in all individuals, and it is only the skin cell's ability to repair the damage that prevents the rapid development of rampant skin cancer. However, with long term exposure, repeated errors in this repair mechanism may result in cancer formation.

For example, the sun emits a broad variety of electromagnetic radiation, including the ultraviolet (UV) spectrum of photons. The UV spectrum is found below 400 nm, is not visible to the human eye, and can be separated into three categories: UV-A (320-400 nm), UV-B (280-320 nm), and UV-C (10-280 nm). Rays of less than 320 nm are responsible for sunburn and are most often filtered out by glass and even smog; however, large amounts of these damaging rays can penetrate 1 foot of water, light clouds, or fog inflicting damage to the skin. While UV-B is the agent chiefly responsible for skin cancer and skin pigmentation, UV-A does cause other undesirable damage to the skin. Specifically, while the spectral range of UV-A is too high to cause sunburn, it still damages the skin. UV-C rays are filtered out by ozone and virtually never reach the surface. However, continuingly diminishing ozone levels in the stratosphere has led to increased UV-A and UV-B exposure. Bright sky, sand and snow may also increase UV-A and UV-B exposure by reflecting these harmful rays back upwards. The skin responds to sunlight by thickening the epidermis and increasing the production of melanin by melanocytes to help protect the skin. Sun exposure also causes functional changes in Langerhan's cells of the epidermis, which has debilitating immunologic consequences. Since the body responds by adding melanin pigment to the skin as a self protection mechanism, it should not be surprising that individuals with less melanin in their skin to begin with, are more prone to the harmful effects of the sun's rays.

The EPA holds guidelines on the amount of incident UV radiation that they translate to a 1-10 scale. The EPA calculates, and makes predictions of UV radiation in terms of units of energy per unit area per second and then measures its projections throughout that day, making adjustments to those values as necessary which it updates and reports on its website. The peak exposure is given at the sun's zenith during the course of the day and is often given as the ‘UV score’ for that day with tapering values during early morning or late in the afternoon. On this scale, a score of 0-2 indicates a very low amount of UV radiation exposure for the peak of that day, and the EPA guidelines tell people to: “wear sunglasses on bright days. In winter, reflection off snow can nearly double UV strength. If you burn easily, cover up and use sunscreen.” At a score of 3-5 the EPA guidelines advice: “take precautions, such as covering up and using sunscreen, if you will be outside. Stay in shade near midday when the sun is strongest.” An EPA guideline score of 6-8 reads: “protection against sunburn is needed. Reduce time in the sun between 11 a.m. and 4 p.m. Cover up, wear a hat and sunglasses, and use sunscreen.” For a score of 8-10 the EPA guideline score suggests to: “take extra precautions. Unprotected skin will be damaged and can burn quickly. Try to avoid the sun between 11 a.m. and 4 p.m. Otherwise, seek shade, cover up, wear a hat and sunglasses, and use sunscreen.” Finally, for a score of 10+ the EPA advises to: “Take all precautions. Unprotected skin can burn in minutes. Beachgoers should know that white sand and other bright surfaces reflect UV and will increase UV exposure. Avoid the sun between 11 a.m. and 4 p.m. Seek shade, cover up, wear a hat and sunglasses, and use sunscreen.” Furthermore, the EPA also'says this in regards to sun exposure in general:

“Regardless of the UV Index, the follow sun safety measures are always encouraged:
Whenever possible, seek shade.
Minimize sun exposure at midday (10:00 am to 4:00 pm).
Use a broad spectrum sunscreen with Sun Protection Factor (SPF) 15 or higher on exposed areas.
Reapply sunscreen every 2 hours, especially after swimming or perspiring.
Wear a wide-brimmed hat and clothing that covers your body.
Wear UV-protective sunglasses.
Avoid sun lamps and tanning parlors.
Watch for the UV Index Daily.”

The one drawback to these guidelines is that the person must know their UV exposure. A variety of ultraviolet sensing devices exist with a wide range of uses including not just measuring unintentional UV sun exposure but often measuring intentional UV irradiation as used to sterilize manufacturing equipment, water and help test and dry house paints. However, none of these types of sensors have ever been applied to a consumer good in a way that could communicate to a consumer their level of UV exposure.

Likewise, containers and dispensers are well-known in the related art. Hand held containers are as a general rule easy to hold and easy to dispense from. Further, most of these containers include labels. For example, U.S. Pat. No. 6,857,211 issued to Grasso outlines the use of a three-dimensional label and includes a method used in manufacturing the same label. Grasso's label design includes a section that is level with the container and a further section that extends off the surface which can be shaped or formed giving a three-dimensional effect to the label. U.S. Pat. No. 5,024,014 by Swierczek describes the attachment of a label/coaster to a beverage container by an adhesive also. However, these patents pertain in spirit to labels for advertising purposes and a method of attachment and lay no claim to the application of containers or labels that incorporate environmental sensors, such as the UV exposure sensors.

Accordingly, a need exists for a bottle or container that incorporates an environmental sensor, such as a UV sensing device that can be used to educate a consumer about their exposure to potentially harmful UV radiation.

### SUMMARY OF THE INVENTION

The current invention is directed to a novel portable environmental exposure indicator device that can be used in conjunction with a consumer container, such as a bottle of sunscreen or on a beverage container.

In one embodiment, the exposure indicator sensing device includes an informed guide to aid a user in making their own judgment as to their own personal acceptable level of exposure.

In still another embodiment, a number of environmental factors may be monitored, such as, for example, UV, heat or temperature, through for example a heat sensing resin. In one such embodiment, the heat sensing resin is a light susceptible color change colorant (photochromism compound) that is incorporated into a polypropylene/polyethylene resin. In such an embodiment, the UV/heat sensing material may be mixed in a plurality of scaled ratios to form a sensor having a gradated range of UV/heat sensitive material.

In yet another embodiment, the exposure indicator sensing device may be included in or on other items other than consumer containers, such as, for example, credit cards, gift cards, surf boards, snow boards, outdoor gear, key chains, hats, wallets, bill folds, or boats and automobiles.

In still yet another embodiment, the exposure indicator sensing device may be included on other consumer goods not related to determining UV exposure for a person. For example, in one embodiment a sensing device could be place on a paint can to allow users to know if there is enough incident UV radiation to most efficiently aid in drying the paint.

### BRIEF DESCRIPTION OF THE DRAWINGS

These and other features and advantages of the present invention will be better understood by reference to the following detailed description when considered in conjunction with the accompanying drawing wherein:

FIG. 1A shows a container having an integrated UV exposure indicator sensor in accordance with the present invention;

FIG. 1B shows a cross section of the UV exposure indicator sensing strip in accordance with the present invention; and

FIG. 2 shows a cross-sectional view of a container having an integrated UV exposure indicator sensor in accordance with the present invention.

### DETAILED DESCRIPTION OF THE INVENTION

The present invention relates generally to environmental exposure sensors, such as, for example, UV exposure indicator sensors and their use with consumer items. Specifically, this invention pertains to the novel application of an environmental sensor, such as a UV or heat sensor to the surface of a bottle or container to be used as a means of providing its user with information about the ambient environment (e.g., UV or heat radiation) incident on said bottle or container and therefore the UV radiation to which the user is being exposed.

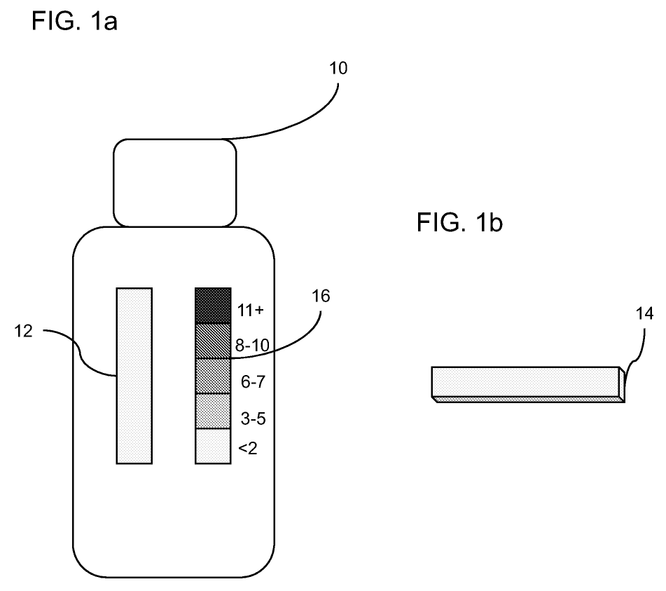

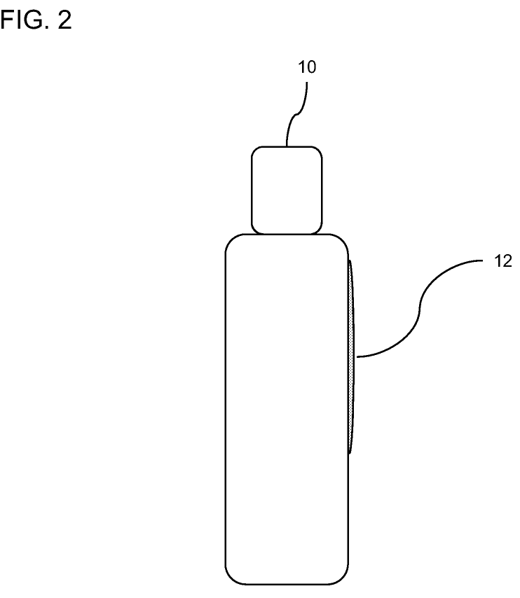

For example, in one embodiment shown schematically in FIGS. 1 and 2, the invention is directed to a consumer item, such as a bottle (10) that includes on its surface by attachment, embedding or other means, an environmental exposure sensor, such as a UV or heat exposure indicator sensor (12). One exemplary environmental exposure indicator sensor would be a heat or UV exposure indicator sensing strip (14). as shown in FIG. 14. The manner of attachment of the sensor can be varied, for example, as shown in FIG. 2 shows a cross-section of the device whereby one portion of the UV or heat exposure indicator sensor (12) lay flush against the surface of the container (10) such that the edges are rounded. In this embodiment, the UV exposure indicator sensor's edge is shown raised against the surface of the container. Between these surfaces an adhesive may be applied to bond the surfaces.

Although one exemplary container is shown in the figures, the only requirements of the current invention are the application of an environmentally sensitive material to the surface or portion of the surface of an otherwise normal bottle or dispenser such that a user is provided information about the items exposure to a particular environmental influence. The bottle itself is unremarkable in size or shape or other non-standard complexity except for the addition of the exposure indicator sensor applied to its surface that changes in response to continued exposure to a particular environmental factor.

The bottle's surface may or may not be modified to accommodate said exposure indicator sensor; this being the only modification to the design and perhaps manufacture of bottles in general. In one embodiment, it is suggested that the exposure indicator sensor, such as a UV or heat exposure indicator sensor be made flush to the surface of the container so that the surfaces can be bonded together easily by means of a simple adhesive, but is in no way imposes a limitation to the variety of methods that may be employed to join the two surfaces.

Aside from the particular manner in which the exposure indicator sensor is either embedded in or otherwise attached to a bottle, container or dispenser, there is no particular requirement or unique aspect of the bottle itself except that it of course, fulfills the function of a bottle, i.e. it holds a liquid or some other material and is capable of dispensing such contents and could apply to any number of containers including but not limited to lotion bottles, such as for sunscreen or skin replenishment creams or other skin products; a beverage container for water, sports drinks, etc. or paint can or any other type of container designed for holding and dispensing products.

Although the above discussion has focused on integration of a environmental exposure indicator sensor with a container, the sensing device may also be included in or on other consumer items, such as, for example, credit cards, gift cards, surf boards, snow boards, outdoor gear, sunglasses, key chains, hats, wallets, bill folds, or boats and automobiles.

Likewise, the environment exposure indicator sensor may be molded during manufacturing to any desirable shape for the purposes of attaching it to a bottle's surface. Such attachment methods include but are not limited to the use of an adhesive or molding the sensor to form a confluent piece of said container. The size and shape of the exposure indicator sensor is of no particular import aside from that it should be readily detectable with the human eye for ease of use.

In one embodiment, the sensor is a UV or heat exposure indicator sensor. Where the environmental exposure indicator sensor is a UV or heat exposure indicator sensor, any suitable UV or heat sensor capable of providing exposure information to a user may be used. For example, the sensor may be a light susceptible color change colorant (photochromism compound) that is mixed into a polypropylene/polyethylene resin in high concentration. These materials, when diluted with a PP/PE resin for moldings, exhibit color intensely under strong sunlight or ultraviolet radiation, whereas they restore to their original color in the dark and these reversible changes can be repeated again and again. On exemplary UV sensing resin is Photopia® Ink, which is manufactured by Matsui International Co., Inc. Such resins and materials typically change color when exposed to particular levels of UV radiation. The materials can have a variety of color palates to choose from, such as yellow to brown for example, and is the device favored for use in this patent, but its use is not intended to limit the field of this patent to just one type of UV detector. Other exemplary UV exposure indicator sensors include vacuum photodiodes, which can also be made to detect UV radiation. Variants on these devices include those that measure accumulated UV energy over time or measure UV flux which is the UV radiation from moment to moment. Spectrophotometers can also include means of converting the amount of incident UV radiation into a digital display, and are further capable of tallying the amount of cumulative radiation to which an individual has been exposed. Any of these devices may be incorporated into the current invention.

Where a UV or heat sensing resin is used, a variety of colors are available to choose from as provided by Matsui International Co., Inc., all changing to a variety of different colors with specific levels of UV or heat exposure. Because the use for the heat sensitive resin is so similar to that of the employment of the UV resin, the use of the UV resin will be discussed; however, the similar use of the heat sensitive resin will be implied for simplicity.

The UV exposure indicator sensing resin is a solid plastic at room temperature, but may be molded during manufacturing to any desirable shape for the purposes of attaching it to a bottle's surface. The UV or heat exposure indicator sensor may also be shaped into a variety of different forms as desired including but not limited to circles, triangles, or other more complex molds (such as the shape of a person sunbathing). The resin may also be rounded along the sides to bring the otherwise raised edges flush and smooth with the container. The UV or heat exposure indicator sensor may also be embedded into the surface of the container as well to help bring its edges flush with the walls of the container. An exemplary exposure indicator sensor design might take the form of a rectangular of sensing material 1 cm by 5 cm long strip or any quantity where a change in the color of a particular UV sensitive resin or other UV sensitive material used for this purpose is easily distinguishable to the human eye.

As discussed above, this invention relates to the integration of an environmental exposure indicator sensor with a consumer item. The means by achieving these results may be varied and include but are not limited to the use of an adhesive to directly apply the sensor, which is applied flush to a bottle or container and/or its application by embedding the resin into the surface of a bottle or container.

In one preferred embodiment, as shown in FIG. 1a, a scale (16), such as a color card depicting the various grades of shading that the UV detecting material is capable of turning in response to various intensities of UV radiation is included on or with the container, thus allowing the user to compare the color of the UV detecting material to the various shades on the card and assign a meaningful value to the UV exposure incident on the UV strip at a given moment. For example, the card could be gauged to provide the user with his UV exposure versus the EPA guidelines discussed in the Background section of this invention. However, the method of interpreting the meaning or value of the amount of color change which indicates the intensity of the incident UV radiation is achieved by but should not be limited to the use of said color card.

Although, the above discussion has described the use of UV/heat resin sensors in which only a single concentration of resin is used, another possible embodiment of the device is to create a sensor having zones with varying amounts of the UV/heat sensitive ink mix to create an integrated gradated scale of color change that is directly indicative of the level of exposure received. For example, in one zone or portion of the sensor 20% UV/heat sensitive ink could be mixed with a polypropylene, while in another 15% UV/heat sensitive ink could be used, then 10% ink for the next and so on. By varying the concentration of resin, different levels of color change would result in the different exposure sensitive zones of the sensor such that color change results in parts of the scale that have little UV/heat sensitive ink, such as, for example, 5%, would indicate a strong UV/heat presence for that day, while results in another portion of the sensor, such as, for example the 20% zone might only indicate moderate exposure. Such a gradated sensor would then combine the UV/heat sensor and the exposure key described above into a single device such that when a specific portion or zone of the sensor changed color the user would immediately be informed as the level of exposure received.

Finally, it should be understood that the use of this device is only meant to provide very simple guidelines and is not meant to guarantee one's safety against UV or heat radiation even if followed precisely. One must use their own judgment and good sense in weighing risk factors such as skin complexion, clothing, altitude, latitude, medical history, and other factors to help determine their own level of exposure. While both the device and the guidelines put forward by the EPA (attached as appendix A to this disclosure and incorporated herein by reference) may be used to help raise public awareness to the dangers of excessive UV exposure and lower their chance for getting sunburned or skin cancer, it should be noted that the detection of incident UV radiation is only one of several factors listed previously that is relevant to a person's risk of damaging exposure to the sun's more harmful rays, and hence only part of their combined risk for getting sunburned or skin cancer.

Although the invention has been described in several embodiments for manufacture, it should not be limited to those embodiments including but not limited to its construction, construction materials—including the sensor itself, the materials chosen as the method of UV or heat detection, or the type of material making up the bottle, shape, size, or bonding methods. Further, it is expected that persons skilled in the art can and will design alternative environmental sensing bottles that are within the scope of the following claims either literally or under the Doctrine of Equivalents.

What is claimed is:

1. An environmental exposure indicating article comprising:
a body defining an external surface;
at least two indicator zones integrated onto said external surface of said body, said indicator zones being formed from different concentrations of a sensing material, the sensing material being selectively sensitive to an environmental factor and designed to undergo a visible change in response to an exposure to said environmental factor; and
wherein the exposure to said environmental factor needed to activate the visible change in each indicator zone is dependent on the concentration of sensing material disposed in the indicator zone.

2. The article described in claim 1, wherein the article is selected from the group consisting of a sunscreen lotion container, beverage container, credit cards, gift cards, surf boards, snow boards, outdoor gear, sunglasses, keychains, and clothing.

3. The article described in claim 1, wherein the body is made of a material selected from the group consisting of aluminum, glass, and plastic.

4. The article described in claim 1, wherein the visible change of the sensing material consists of a change in color, and wherein the extent of such change provides a means of indicating the varying degrees or intensities of exposure to a environmental factor.

5. The article described in claim 1, wherein the sensing material is a resin designed to sense exposure to UV or heat radiation.

6. The article described in claim 5, wherein the sensing material is capable of detecting UV radiation at wavelengths including but not limited to those consistent with UVA (315-400 nm), UVB (280-315 nm), and UVC (<280 nm).

7. The article described in claim 5, wherein the sensing material has a temperature sensing range of at least about 32 to 110 degrees Fahrenheit.

8. The article described in claim 5, wherein the sensing material is embedded into the surface of the container.

9. The article described in claim 5, wherein the sensing material is attached with an adhesive.

10. The article described in claim 5, wherein the sensing material is molded to match the contour of the article body.

11. The article described in claim 5, wherein the resin is a polypropylene/polyethylene resin that has incorporated therein a light susceptible color change colorant.

12. The article described in claim 1, wherein the sensing material in each indicator zone has a different shade of color that is separate and distinct.

13. The article described in claim 12, wherein the article also includes a scale that provides information on said exposure level as determined by the relative indicator zone.
